(19) United States
(12) Patent Application Publication
(10) Pub. No.: US 2026/0189040 A1
(43) Pub. Date: Jul. 2, 2026

(54) LOW-VOLTAGE MODULE AND DC CHARGING DOCK

(71) Applicants: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(72) Inventors: Fangyue (Jason) Zhu, Shanghai (CN); Jinshun (Jet) Wang, Suzhou (CN); Haifei (Felix) Yu, Suzhou (CN); Renyi (Ronny) Dou, Suzhou (CN)

(73) Assignees: Tyco Electronics (Suzhou) Ltd., Suzhou (CN); Tyco Electronics (Shanghai) Co., Ltd., Shanghai (CN); Tyco Electronics Technology (SIP) Co., Ltd., Suzhou (CN)

(21) Appl. No.: 19/436,223

(22) Filed: Dec. 30, 2025

(30) Foreign Application Priority Data
Dec. 31, 2024 (CN) 202411997621.1

(51) Int. Cl. H02J 7/70

(52) U.S. Cl. CPC H02J 7/731

(57) ABSTRACT

A Low-voltage module of a DC charging dock includes an insulator and an electrical connection member. The electrical connection member includes a first contact part, a second contact part, and a connection part. The first contact part electrically contacts a PE terminal of the DC charging dock. The second contact part electrically contacts an A-terminal of the DC charging dock. The connection part is fixed to the insulator and electrically connects the first contact part and the second contact part. The Low-voltage module is installed in a plug-in manner into an insertion slot in a charging dock housing of the DC charging dock from an outside. The first contact part and the second contact part respectively electrically contact the PE terminal and the A-terminal when the Low-voltage module is installed in the insertion slot, to electrically connect the A-terminal to the PE terminal.

### CROSS-REFERENCE TO RELATED APPLICATION

This application claims the benefit of the filing date under 35 U.S.C. § 119(a)-(d) of Chinese Patent Application No. CN202411997621.1 filed on Dec. 31, 2024, the whole disclosure of which is incorporated herein by reference.

### FIELD OF THE INVENTION

The present invention relates to the field of electric vehicle charging technology and, more particularly, to a Low-voltage module of a DC charging dock and a DC charging dock comprising the Low-voltage module.

### BACKGROUND OF THE INVENTION

The PE terminal (also known as a grounding protection terminal) and A-terminal (also known as a negative terminal of a low-voltage auxiliary power supply) in the typical DC charging dock are separately provided, which leads to the PE terminal and A-terminal not being grounded together, that is, the PE terminal and A-terminal are not electrically interconnected and grounded together. Therefore, in practical applications, sometimes there may be a large voltage difference between the DC charging dock and the DC charging gun due to the PE terminal and A-terminal not being grounded together. This can lead to a large current in the low-voltage auxiliary circuit connected to the A+ terminal or A-terminal of the DC charging dock, which can easily cause the low-voltage auxiliary circuit to be burned out.

In addition, in order to improve the charging speed of new energy electric vehicles, it is necessary to increase the charging current. Currently, the charging current is as high as 600 A, and it may even increase to 1000 A in the future. When a large current flows through the power terminal of the DC charging dock, a large amount of heat will be generated, which will cause the temperature of the power terminal of the DC charging dock to rise sharply. If the temperature rise cannot be controlled in time, it will lead to safety accidents, such as burning the DC charging dock or other electrical equipment.

In order to control the temperature rise of power terminals, a lead frame is usually installed in the DC charging dock and a Low-voltage module is integrated on the lead frame. The Low-voltage module of the DC charging dock includes a temperature sensor and a thermal pad wrapped around the temperature sensor. The thermal pad is in thermal contact with the power terminal, and the temperature sensor is electrically connected to the lead frame. However, the lead frame has a large volume and needs to be pre-installed in the charging dock housing, which is very inconvenient to use. In addition, in order to facilitate the installation of the lead frame, the charging dock housing needs to adopt a split design, which leads to a complex structure of the charging dock housing. In addition, the existing lead frame needs to be able to rotate between the locking position of locking the power terminal and the unlocking position of unlocking the power terminal, which will make the lead frame and charging dock housing more complex, assembly more difficult, and cost higher.

### SUMMARY OF THE INVENTION

A Low-voltage module of a DC charging dock includes an insulator and an electrical connection member. The electrical connection member includes a first contact part, a second contact part, and a connection part. The first contact part electrically contacts a PE terminal of the DC charging dock. The second contact part electrically contacts an A-terminal of the DC charging dock. The connection part is fixed to the insulator and electrically connects the first contact part and the second contact part. The Low-voltage module is installed in a plug-in manner into an insertion slot in a charging dock housing of the DC charging dock from an outside. The first contact part and the second contact part respectively electrically contact the PE terminal and the A-terminal when the Low-voltage module is installed in the insertion slot, to electrically connect the A-terminal to the PE terminal.

### BRIEF DESCRIPTION OF DRAWINGS

The invention will now be described by way of example with reference to the accompanying figures, of which:

FIG. 1 is a perspective view of a DC charging dock according to an exemplary embodiment;

FIG. 2 is an exploded view of the DC charging dock of FIG. 1;

FIG. 3 is a perspective view of a Low-voltage module, a PE terminal, an A-terminal, and a power terminal of the DC charging dock of FIG. 1;

FIG. 4 is an exploded view of the Low-voltage module of FIG. 3 and the power terminal of FIG. 3;

FIG. 5 is a front side perspective view of the Low-voltage module of FIG. 3, the PE terminal of FIG. 3, and the A-terminal of FIG. 3;

FIG. 6 is a rear perspective view of the low-voltage module of FIG. 3, the PE terminal of FIG. 3, and the A-terminal of FIG. 3;

FIG. 7 is an exploded view of the Low-voltage module of FIG. 3, the PE terminal of FIG. 3, and the A-terminal of FIG. 3;

FIG. 8 is a perspective view of the Low-voltage module of FIG. 3;

FIG. 9 is a partial exploded view of the Low-voltage module of FIG. 3;

FIG. 10 is an exploded view of the Low-voltage module of FIG. 3;

FIG. 11 is a perspective view of conductive leads and a temperature sensor of the Low-voltage module of FIG. 3;

FIG. 12 is a perspective view of the Low-voltage module of FIG. 3;

FIG. 13 is a perspective view of an electrical connection member of the Low-voltage module of FIG. 3;

FIG. 14 is a perspective view of an electrical connection of the Low-voltage module of FIG. 3 in electrical contact with the PE terminal of FIG. 3 and the A-terminal of FIG. 3;

FIG. 15 is a perspective view of the power terminal of FIG. 3; and

FIG. 16 is a side view of a power terminal assembly of the DC charging dock of FIG. 1.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

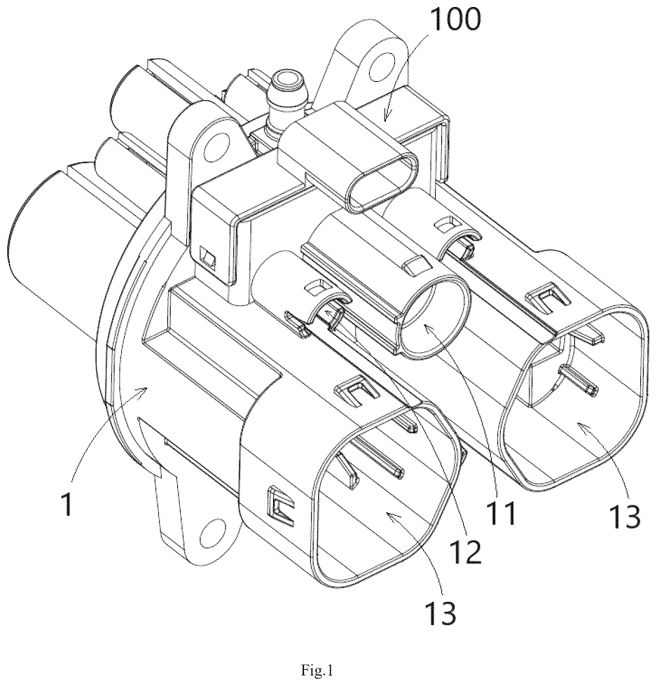

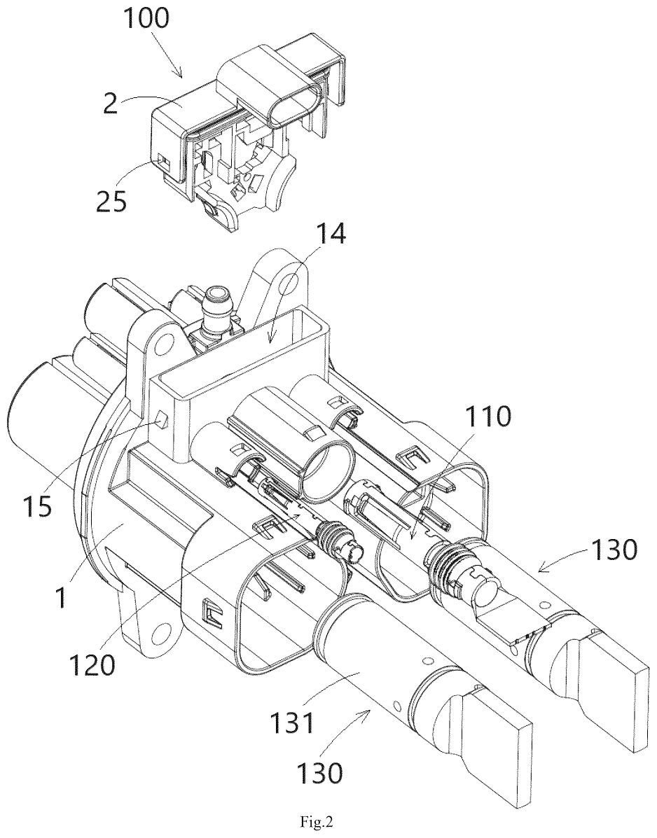

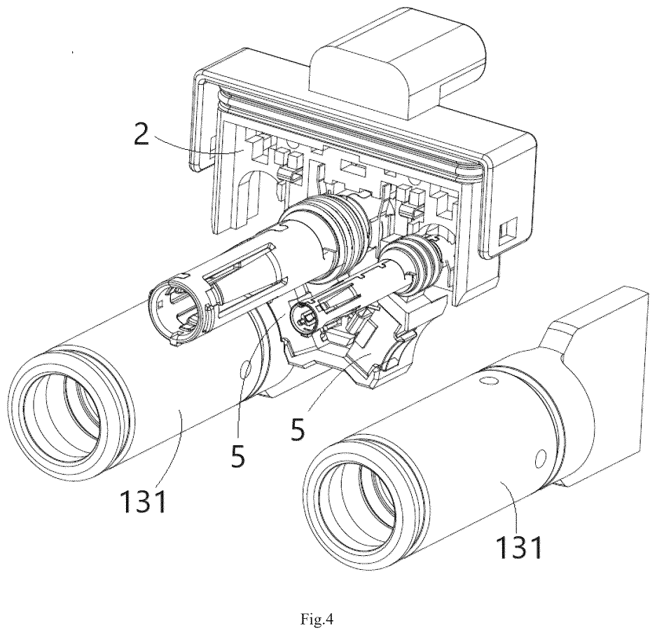

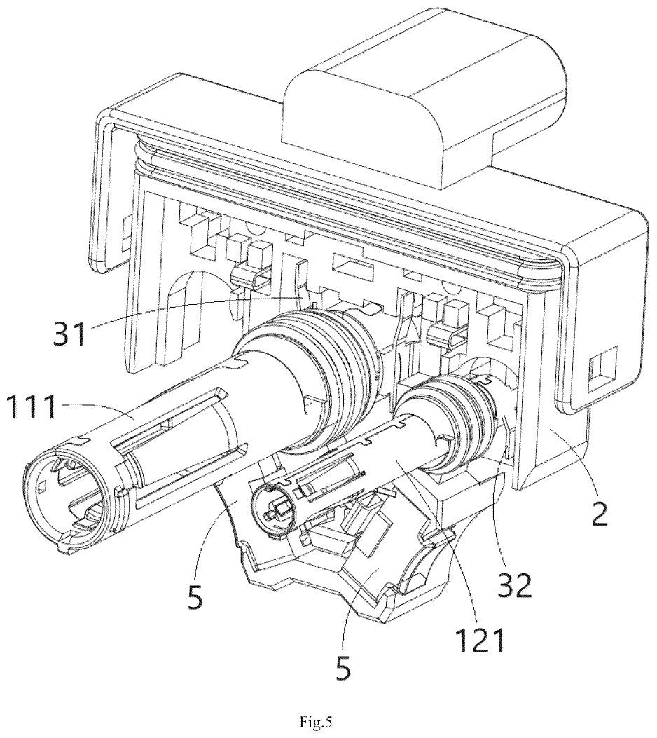

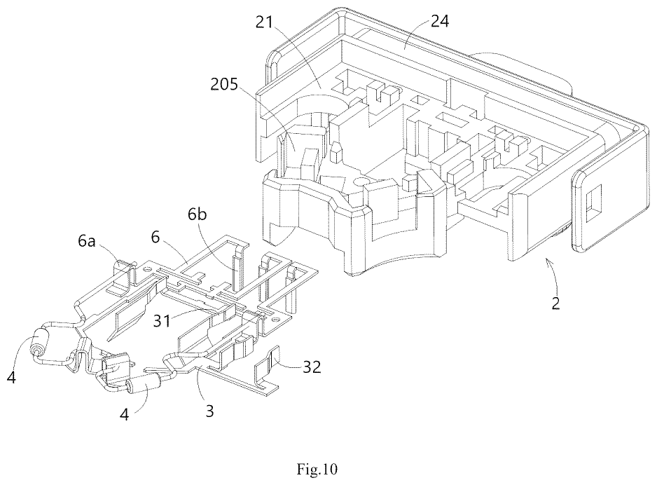

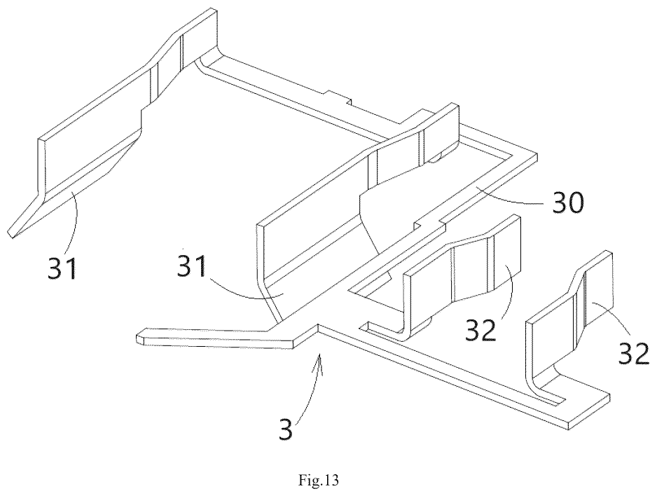

An exemplary embodiment of a Low-voltage module 100 of a DC charging dock will now be described with reference to FIGS. 1-14. The Low-voltage module 100 of the DC charging dock includes an insulator 2, as shown in FIGS. 2-7 and 10, and an electrical connection member 3, as shown in FIGS. 10 and 13. The electrical connection member 3 includes a first contact part 31, a second contact part 32, and a connection part 30. The first contact part 31 is used to make electrical contact with a PE terminal 111, as shown in FIGS. 5-7, of the DC charging dock. The second contact part 32 is used to make electrical contact with an A-terminal 121, as shown in FIGS. 5-7, of the DC charging dock. The connection part 30 electrically connects the first contact part 31 and the second contact part 32 and is fixed to the insulator 2. The Low-voltage module 100 is suitable for external installation in a pluggable manner into an insertion slot 14, as shown in FIG. 2, in a charging dock housing 1. The first contact part 31 and the second contact part 32 make electrical contact with the PE terminal 111 and the A-terminal 121, respectively, when the Low-voltage module 100 is installed in the insertion slot 14, to electrically connect the A-terminal 121 to the PE terminal 111.

The insulator 2 is directly injection molded onto the electrical connection member 3, making the insulator 2 and the electrical connection member 3 an integral piece. This can reduce manufacturing costs and improve production efficiency. The electrical connection member 3 can be an integral stamped part. However, the present invention is not limited to the illustrated embodiments; for example, the electrical connection member 3 may be welded together from multiple components.

As shown in FIG. 13, the first contact part 31 includes a pair of first spring pieces. A pair of first spring pieces is used to clamp the PE terminal 111. The second contact part 32 includes a pair of second spring pieces. A pair of second spring pieces is used to clamp the A-terminal 121. However, the present invention is not limited to the illustrated embodiment, and other suitable elastic contact structures can also be used for the first contact part 31 and the second contact part 32.

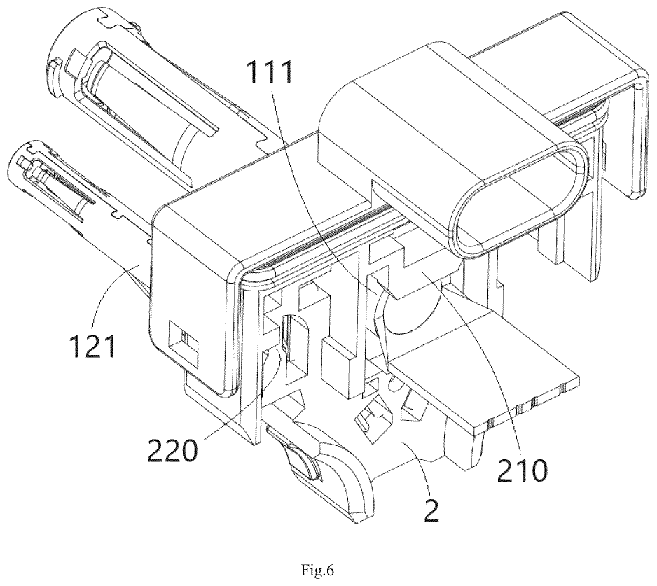

The insulator 2 has a first locking part 210, as shown in FIG. 6, which presses against the PE terminal 111 when the Low-voltage module 100 is installed in the insertion slot 14 to lock the PE terminal 111 in the charging dock housing 1. The insulator 2 has a second locking part 220, as shown in FIG. 6, which rests against the A-terminal 121 when the Low-voltage module 100 is installed into the insertion slot 14, to lock the A-terminal 121 in the charging dock housing 1.

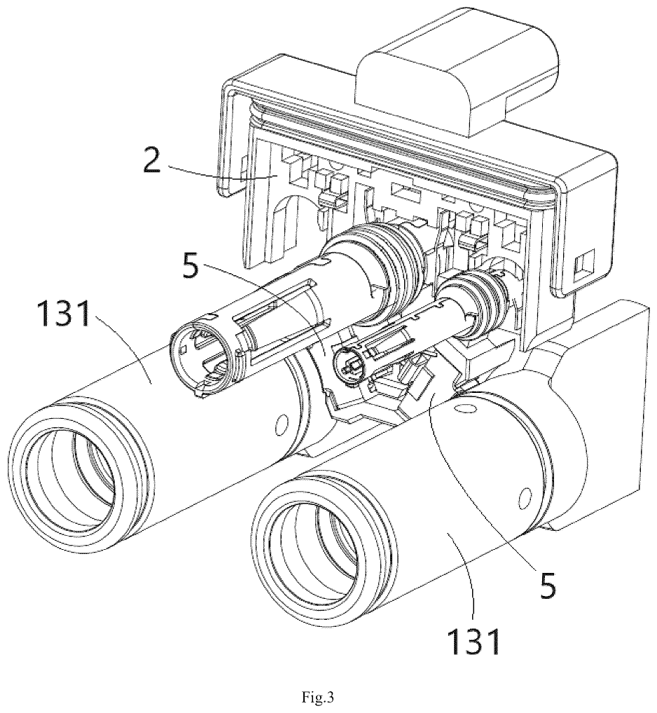

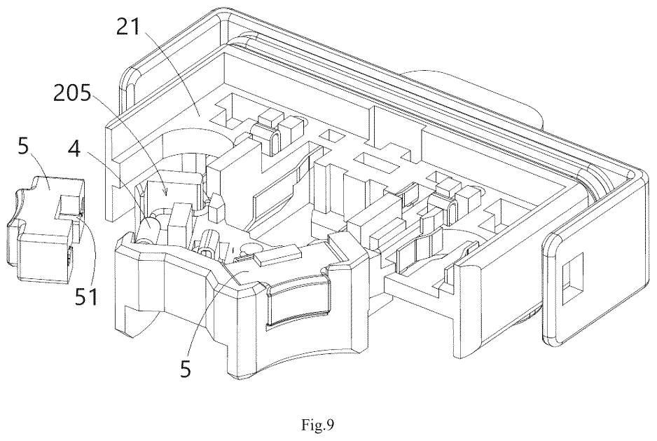

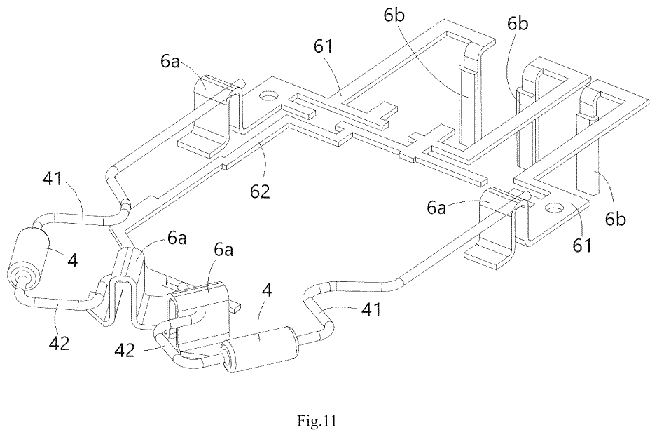

The Low-voltage module 100 further includes a thermal pad 5, as shown in FIGS. 3-5 and 7-9, a temperature sensor 4, as shown in FIGS. 9-11, and a conductive lead 6, as shown in FIG. 11. The thermal pad 5 is assembled onto the insulator 2 for thermal contact with a power terminal 131, as shown in FIGS. 2-4 and 15, of the DC charging dock. The temperature sensor 4 is installed in thermal pad 5 to detect the temperature of the power terminal 131. The conductive lead 6 is set in the insulator 2 and electrically connected to the temperature sensor 4. The thermal pad 5 comes into thermal contact with the power terminal 131 when the Low-voltage module 100 is installed in the insertion slot 14, to transfer the heat of the power terminal 131 to the temperature sensor 4.

The insulator 2 is directly injection molded onto the conductive lead 6 and the electrical connection member 3, making the conductive lead 6, the electrical connection member 3, and the insulator 2 an integral piece.

As shown in FIGS. 10-11, the conductive lead 6 has a connection end 6a for electrical connection with the temperature sensor 4 and an external pin 6b for electrical connection with a connector located outside the charging dock housing 1.

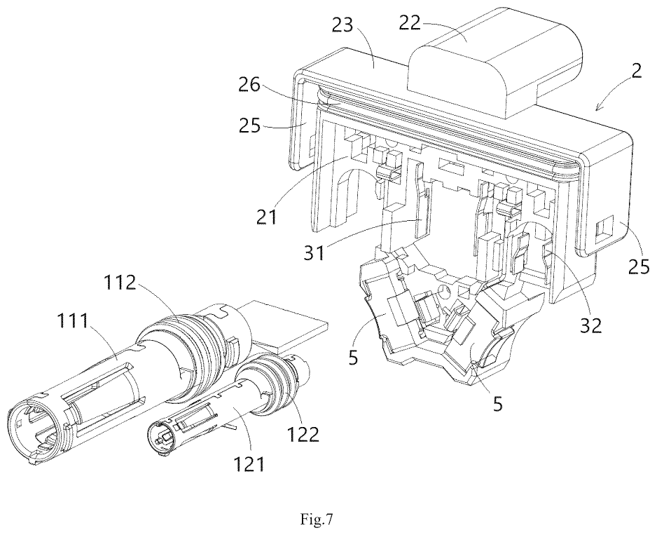

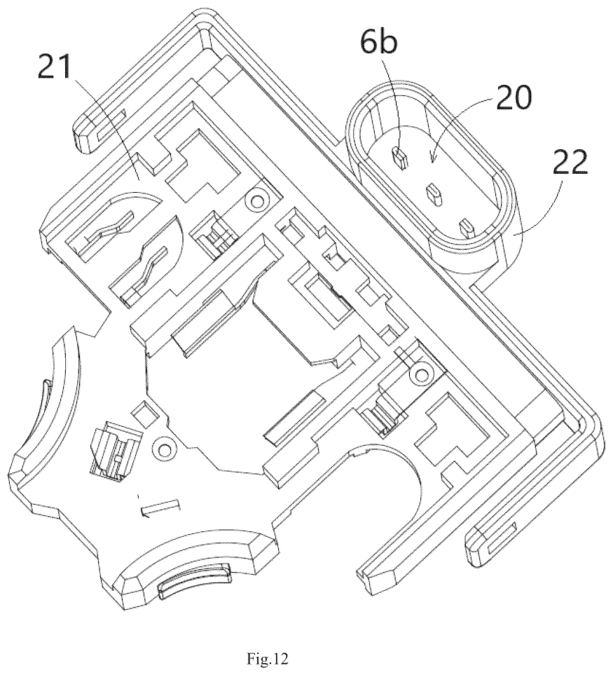

As shown in FIGS. 7 and 12, the insulator 2 includes a bracket part 21 and a mating part 22. The bracket part 21 is suitable for inserting into the insertion slot 14 of the charging dock housing 1. The mating part 22 is adapted to be positioned on the outside of the charging dock housing 1. The thermal pad 5 and temperature sensor 4 are installed on the bracket part 21, and the mating part 22 has an insertion cavity 20, as shown in FIG. 12, that allows the connector to be inserted. The external pin 6b of the conductive lead 6 extends into the insertion cavity 20 to be electrically connected to the inserted connector.

As shown in FIG. 10, a sealing ring installation groove 24 is formed on the outer peripheral surface of the bracket part 21. The Low-voltage module 100 also includes a sealing ring 26, as shown in FIG. 7, installed in the sealing ring installation groove 24, which is suitable for being compressed between the bracket part 21 and the inner wall surface of the insertion slot 14 of the charging dock housing 1 to achieve sealing between the two.

As shown in FIG. 7, the bracket part 21 has a cover plate part 23 for covering the entrance of the insertion slot 14 of the charging dock housing 1, and the insulator 2 also includes multiple buckles 25 connected to the periphery of the cover plate part 23. The multiple buckles 25 are distributed around the outer periphery of the cover plate part 23 and are used to engage with multiple protrusions 15, as shown in FIG. 2, on the charging dock housing 1, respectively, to lock the Low-voltage module 100 to the charging dock housing 1.

As shown in FIG. 11, the conductive lead 6 includes a positive lead 61 and a negative lead 62 electrically connected to the positive pin 41 and the negative pin 42 of the temperature sensor 4, respectively. The external pins 6b of the positive lead 61 and the negative lead 62 extend into the insertion cavity 20 of the mating part 22 for electrical connection with the inserted connector. As shown in FIG. 11, the connection end 6a of the positive lead 61 is adapted to be electrically connected to the positive pin 41 of the temperature sensor 4 in a pluggable manner. The connection end 6a of the negative lead 62 is suitable for plug-in electrical connection with the negative pin 42 of the temperature sensor 4. The connection end 6a of the positive lead 61 is in an elastic clip shape, suitable for clamping the positive pin 41 of the temperature sensor 4. The connection end 6a of the negative lead 62 is in an elastic clip shape, suitable for clamping the negative pin 42 of the temperature sensor 4.

The Low-voltage module 100 includes multiple thermal pads 5, as shown in FIGS. 3-5 and 7-9, and multiple temperature sensors 4, as shown in FIGS. 10-11, respectively arranged in the multiple thermal pads 5. The multiple thermal pads 5 are used to make thermal contact with multiple power terminals 131, and the multiple temperature sensors 4 are used to detect the temperature of the multiple power terminals 131.

As shown in FIG. 11, the conductive lead 6 includes multiple positive leads 61 and a single negative lead 62. The connection ends 6a of multiple positive leads 61 are electrically connected to the positive pins 41 of multiple temperature sensors 4, and the single negative lead 62 has multiple connection ends 6a electrically connected to the negative pins 42 of multiple temperature sensors 4. The external pins 6b of multiple positive leads 61 and the external pins 6b of the single negative lead 62 extend into the insertion cavity 20 of the mating part 22 for electrical connection with the inserted connector.

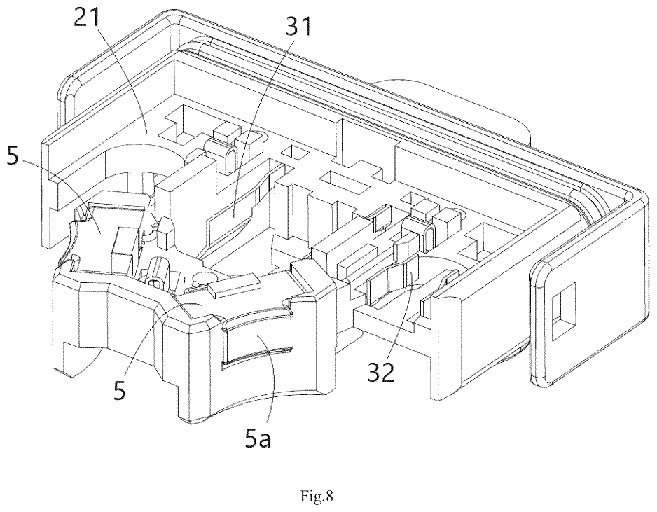

As shown in FIG. 9, the thermal pad 5 is in the form of a block, and a recessed receiving part 205 is formed on the insulator 2. The thermal pad 5 is positioned and installed in the receiving part 205. A mounting slot 51 is formed in the thermal pad 5, and the main body of the temperature sensor 4 is inserted into the mounting slot 51 of the thermal pad 5. The positive pin 41 and negative pin 42 of the temperature sensor 4 extend from the thermal pad 5. The thermal pad 5 has an arc-shaped contact surface 5a, as shown in FIG. 8, suitable for being attached to the outer peripheral surface of the power terminal 131 to increase the thermal contact area between the thermal pad 5 and the power terminal 131.

Please note that the Low-voltage module 100 of the present invention is not limited to the illustrated embodiment. For example, in another exemplary embodiment of the present invention, the Low-voltage module 100 further includes a circuit board that is mounted and fixed to the insulator 2. For ease of installation, the insulator 2 can be in the shape of a shell. The first contact part 31 and the second contact part 32 of the aforementioned electrical connection member 3 are contact spring pieces fixed to the circuit board, and the connection part 30 of the aforementioned electrical connection member 3 can be a conductive trace formed on the circuit board. In addition, in this embodiment, the Low-voltage module 100 of the DC charging dock also includes a thermal pad 5, a temperature sensor 4, and an external pin 6b. The thermal pad 5 is assembled onto the circuit board for thermal contact with the power terminal 131 of the DC charging dock. The temperature sensor 4 is installed in thermal pad 5 to detect the temperature of power terminal 131. The external pin 6b is fixed to the circuit board for electrical connection with a connector located outside the charging dock housing 1. The temperature sensor 4 is electrically connected to the external pin 6b through a conductive trace on the circuit board. The thermal pad 5 comes into thermal contact with the power terminal 131 when the Low-voltage module 100 is installed in the insertion slot 14, to transfer the heat from the power terminal 131 to the temperature sensor 4.

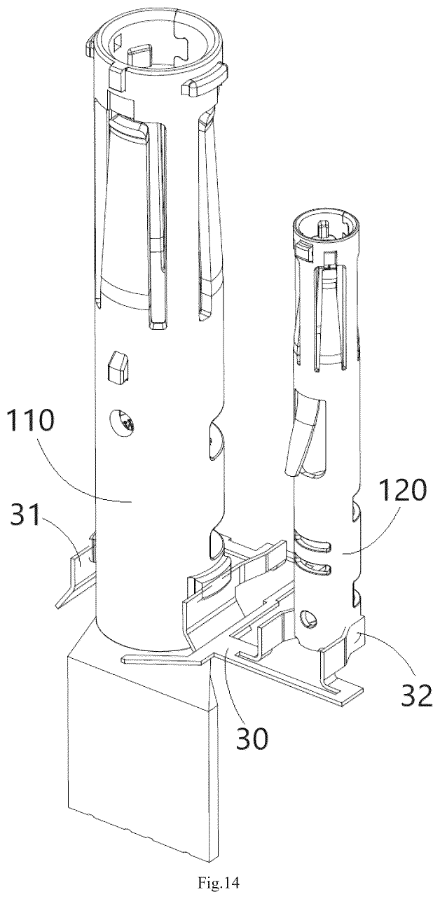

An exemplary embodiment of a DC charging dock will now be described with reference to FIGS. 1-16. The DC charging dock includes a charging dock housing 1, as shown in FIGS. 1-2, a PE terminal assembly 110, as shown in FIGS. 2 and 14, an A-terminal assembly 120, as shown in FIGS. 2 and 14, and the Low-voltage module 100 according to FIGS. 1-14. As shown in FIGS. 1-2, the charging dock housing 1 is formed with a first socket 11, a second socket 12, and an insertion slot 14 communicated with the first socket 11 and the second socket 12. The PE terminal assembly 110 includes a PE terminal 111, as shown in FIGS. 5-7, and is inserted into the first socket 11. The A-terminal assembly 120 includes an A-terminal 121, as shown in FIGS. 5-7, and is inserted into the second socket 12. The Low-voltage module 100 of the DC charging dock is inserted into the insertion slot 14 from the outside of the charging dock housing 1. The first contact part 31 and the second contact part 32 of the electrical connection member 3 are in electrical contact with the PE terminal 111 and the A-terminal 121, respectively, to electrically connect the A-terminal 121 to the PE terminal 111.

As shown in FIG. 7, the PE terminal assembly 110 further includes a grounding cable and a first sealing component 112. The grounding cable is electrically connected to the PE terminal 111 and led out from the first socket 11 of the charging dock housing 1. The first sealing component 112 is injected onto the PE terminal 111. The first sealing component 112 is compressed between the PE terminal 111 and the inner wall surface of the first socket 11 to achieve sealing between the two.

As shown in FIG. 7, the A-terminal assembly 120 further includes a second sealing component 122. The second sealing component 122 is injection molded onto the A-terminal 121. The second sealing component 122 is compressed between the A-terminal 121 and the inner wall surface of the second socket 12 to achieve sealing between the two.

As shown in FIG. 2, multiple protrusions 15 are formed on the outer side of the peripheral wall of the insertion slot 14 of the charging dock housing 1. These protrusions 15 are distributed around the insertion slot 14 at intervals and are used to respectively engage with multiple buckles 25 on the insulator 2 of the Low-voltage module 100, in order to lock the Low-voltage module 100 to the charging dock housing 1.

The axial direction of the insertion slot 14 is perpendicular to the axial direction of the first socket 11 and the second socket 12, and the Low-voltage module 100 is inserted into the insertion slot 14 along the radial direction of the first socket 11 and the second socket 12.

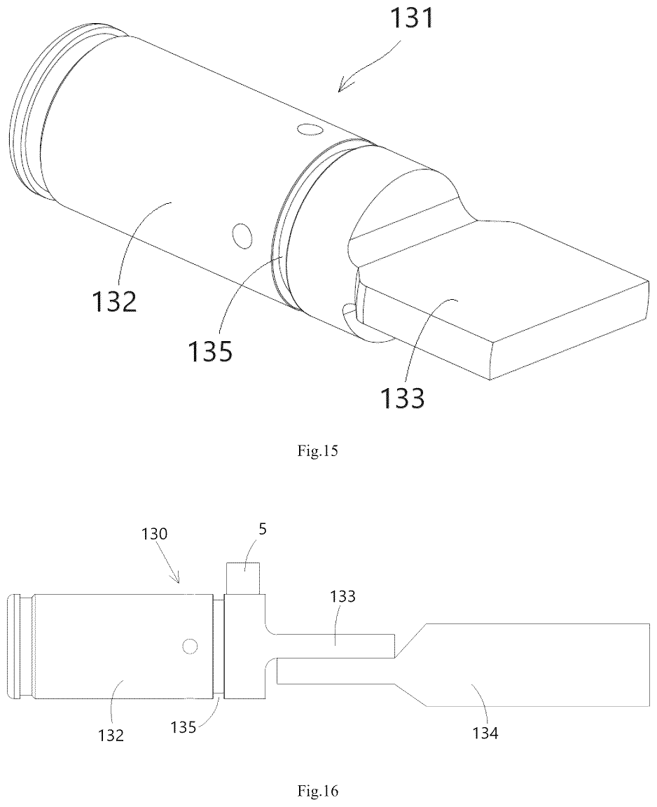

As shown in FIG. 1, a third socket 13 is also formed in the charging dock housing 1, and the insertion slot 14 is communicated with the third socket 13. The DC charging dock also includes a power terminal assembly 130, as shown in FIGS. 2 and 16, inserted into the third socket 13. As shown in FIGS. 2-4 and 15, the power terminal assembly 130 includes a power terminal 131. The thermal pad 5 of the Low-voltage module 100 is in thermal contact with the power terminal 131 to transfer the heat of the power terminal 131 to the temperature sensor 4 of the Low-voltage module 100.

As shown in FIG. 16, the power terminal assembly 130 further includes a high-voltage cable 134 and a sealing plug (not shown). The high-voltage cable 134 is electrically connected to the power terminal 131 and led out from the charging dock housing 1. The sealing plug is fitted onto the high-voltage cable 134 and inserted into the third socket 13. The sealing plug is compressed between the high-voltage cable 134 and the inner wall surface of the third socket 13 to achieve sealing between the two.

As shown in FIGS. 15-16, the power terminal 131 includes a cylindrical part 132 and a welding part 133. The cylindrical part 132 is used for mating with a mating power terminal. The welding part 133 is connected to the rear end of the cylindrical part 132 for welding to the high-voltage cable 134. The thermal pad 5 is in thermal contact with the outer peripheral surface of the cylindrical part 132 of the power terminal 131 and adjacent to the welding part 133 of the power terminal 131.

As shown in FIGS. 15-16, a seal installation groove 135 is formed on the rear end of the cylindrical part 132 of the power terminal 131. The power terminal assembly 130 also includes a sealing ring installed in the seal installation groove 135, which is pressed between the cylindrical part 132 of the power terminal 131 and the inner wall surface of the third socket 13 of the charging dock housing 1 to achieve sealing between the two.

As shown in FIGS. 1-2, the charging dock housing 1 has multiple third sockets 13, and the DC charging dock has multiple power terminal assemblies 130 that are respectively inserted into the multiple third sockets 13. The insertion slot 14 is communicated with the multiple third sockets 13, and the Low-voltage module 100 includes multiple thermal pads 5 in thermal contact with the power terminals 131 of multiple power terminal assemblies 130, and multiple temperature sensors 4 for detecting the temperature of the multiple power terminals 131. In the illustrated embodiment, the charging dock housing 1 has two third sockets 13, the DC charging dock has two power terminal assemblies 130, and the Low-voltage module 100 includes two thermal pads 5 and two temperature sensors 4. In the illustrated embodiment, the charging dock housing 1 is an integral injection molded part.

In the aforementioned exemplary embodiments according to the present invention, the electrical connection member 3 in the Low-voltage module 100 of the DC charging dock can electrically interconnect the PE terminal 111 and the A-terminal 121 of the DC charging dock, thereby achieving common ground between the PE terminal 111 and A-terminal 121, effectively preventing the low-voltage auxiliary circuit of the DC charging dock from being burned out. Additionally, in the aforementioned exemplary embodiments according to the present invention, the Low-voltage module 100 is not only small in size, but also can be directly inserted into the insertion slot 14 in the charging dock housing 1 from the outside, making its installation and use very convenient. Further, in the aforementioned exemplary embodiments according to the present invention, the Low-voltage module 100 of the DC charging dock integrates a temperature sensor 4 for detecting the temperature of the power terminal 131 of the DC charging dock, thereby preventing the DC charging dock from being burned due to excessive temperature.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A Low-voltage module of a DC charging dock, comprising:
an insulator; and
an electrical connection member, including:
a first contact part electrically contacting a PE terminal of the DC charging dock;
a second contact part electrically contacting an A-terminal of the DC charging dock; and
a connection part fixed to the insulator and electrically connecting the first contact part and the second contact part, the Low-voltage module is installed in a plug-in manner into an insertion slot in a charging dock housing of the DC charging dock from an outside, the first contact part and the second contact part respectively electrically contact the PE terminal and the A-terminal when the Low-voltage module is installed in the insertion slot, to electrically connect the A-terminal to the PE terminal.

2. The Low-voltage module of the DC charging dock of claim 1, wherein the insulator is directly injection molded onto the electrical connection member, such that the insulator and the electrical connection member are an integral piece.

3. The Low-voltage module of the DC charging dock of claim 1, wherein the electrical connection member is an integral stamped part.

4. The Low-voltage module of the DC charging dock of claim 1, wherein the first contact part has a pair of first spring pieces, the pair of first spring pieces clamp the PE terminal, and/or the second contact part has a pair of second spring pieces, the pair of second spring pieces clamp the A-terminal.

5. The Low-voltage module of the DC charging dock of claim 1, wherein the insulator has a first locking part, the first locking part is pressed against the PE terminal when the Low-voltage module is installed into the insertion slot to lock the PE terminal in the charging dock housing, and/or the insulator has a second locking part that rests against the A-terminal when the Low-voltage module is installed into the insertion slot to lock the A-terminal in the charging dock housing.

6. The Low-voltage module of the DC charging dock of claim 1, further comprising a thermal pad, a temperature sensor, and a conductive lead, the thermal pad is assembled onto the insulator for thermal contact with a power terminal of the DC charging dock, the temperature sensor is provided in the thermal pad to detect a temperature of the power terminal, the conductive lead is provided in the insulator and is electrically connected to the temperature sensor, the thermal pad is in thermal contact with the power terminal when the Low-voltage module is installed in the insertion slot, to transfer a heat of the power terminal to the temperature sensor.

7. The Low-voltage module of the DC charging dock of claim 6, wherein the insulator is directly injection molded onto the conductive lead and the electrical connection member, such that the conductive lead, the electrical connection member, and the insulator are an integral piece.

8. The Low-voltage module of the DC charging dock of claim 6, wherein the conductive lead has a connection end electrically connected to the temperature sensor and an external pin for electrical connection with a connector located outside the charging dock housing.

9. The Low-voltage module of the DC charging dock of claim 8, wherein the insulator has a bracket part and a mating part, the bracket part is inserted into the insertion slot of the charging dock housing, the mating part is positioned outside the charging dock housing, the thermal pad and the temperature sensor are installed on the bracket part, and the mating part has an insertion cavity that allows the connector to be inserted, the external pin of the conductive lead extends into the insertion cavity to be electrically connected to the connector inserted into the insertion cavity.

10. The Low-voltage module of the DC charging dock of claim 9, wherein a sealing ring installation groove is formed on an outer peripheral surface of the bracket part, the Low-voltage module further comprises a sealing ring installed in the sealing ring installation groove, the sealing ring is compressed between the bracket part and an inner wall surface of the insertion slot of the charging dock housing to achieve sealing between the two.

11. The Low-voltage module of the DC charging dock of claim 9, wherein the bracket part has a cover plate part covering an entrance of the insertion slot of the charging dock housing, and the insulator has a plurality of buckles connected to a periphery of the cover plate part, the plurality of buckles are distributed around an outer periphery of the cover plate part and respectively engage a plurality of protrusions on the charging dock housing to lock the Low-voltage module to the charging dock housing.

12. The Low-voltage module of the DC charging dock of claim 9, wherein the conductive lead has a positive lead and a negative lead respectively electrically connected to a positive pin and a negative pin of the temperature sensor, external pins of the positive lead and the negative lead extend into the insertion cavity of the mating part for electrical connection with the connector inserted into the insertion cavity.

13. The Low-voltage module of the DC charging dock of claim 12, wherein a connection end of the positive lead is electrically connected with the positive pin of the temperature sensor in a plug-in manner, and/or a connection end of the negative lead is electrically connected with the negative pin of the temperature sensor in a plug-in manner.

14. The Low-voltage module of the DC charging dock of claim 13, wherein the connection end of the positive lead is in an elastic clip shape and clamps the positive pin of the temperature sensor, and/or the connection end of the negative lead is in an elastic clip shape and clamps the negative pin of the temperature sensor.

15. The Low-voltage module of the DC charging dock of claim 9, wherein the Low-voltage module of the DC charging dock comprises a plurality of thermal pads and a plurality of temperature sensors each arranged in one thermal pad, the plurality of thermal pads thermally contact a plurality of power terminals, and the plurality of temperature sensors detect a temperature of the plurality of power terminals.

16. The Low-voltage module of the DC charging dock of claim 15, wherein the conductive lead has a plurality of positive leads and a single negative lead, connection ends of the plurality of positive leads are respectively electrically connected to positive pins of the plurality of temperature sensors, the single negative lead has a plurality of connection ends respectively electrically connected to negative pins of the plurality of temperature sensors, external pins of the plurality of positive leads and the external pin of the single negative lead extend into the insertion cavity of the mating part for electrical connection with the connector inserted into the insertion cavity.

17. The Low-voltage module of the DC charging dock of claim 6, wherein the thermal pad is block shaped, a recessed receiving part is formed on the insulator, the thermal pad is positioned and installed into the receiving part, a mounting slot is formed in the thermal pad, a main body of the temperature sensor is inserted into the mounting slot of the thermal pad, and a positive pin and a negative pin of the temperature sensor extend from the thermal pad.

18. The Low-voltage module of the DC charging dock of claim 17, wherein the thermal pad has an arc-shaped contact surface, the arc-shaped contact surface is attached to an outer peripheral surface of the power terminal to increase a thermal contact area between the thermal pad and the power terminal.

19. The Low-voltage module of the DC charging dock of claim 1, further comprising a circuit board installed and fixed to the insulator, the first contact part and the second contact part of the electrical connection member are contact spring pieces fixed to the circuit board, and the connection part of the electrical connection member is a conductive trace formed on the circuit board.

20. The Low-voltage module of the DC charging dock of claim 19, further comprising a thermal pad, a temperature sensor, and an external pin, the thermal pad is assembled onto the circuit board for thermal contact with a power terminal of the DC charging dock, the temperature sensor is provided in the thermal pad to detect a temperature of the power terminal, the external pin is fixed to the circuit board for electrical connection with a connector located outside the charging dock housing, the temperature sensor is electrically connected to the external pin via a conductive trace on the circuit board, the thermal pad is in thermal contact with the power terminal when the Low-voltage module is installed in the insertion slot, to transfer a heat of the power terminal to the temperature sensor.

21. A DC charging dock, comprising:
a charging dock housing formed with a first socket, a second socket, and an insertion slot in communication with the first socket and the second socket;
a PE terminal assembly including a PE terminal and inserted into the first socket;
an A-terminal assembly including an A-terminal and inserted into the second socket; and
a Low-voltage module, including
an insulator; and
an electrical connection member, including:
a first contact part electrically contacting the PE terminal;
a second contact part electrically contacting the A-terminal; and
a connection part fixed to the insulator and electrically connecting the first contact part and the second contact part, the Low-voltage module is inserted into the insertion slot from an outside of the charging dock housing, the first contact part and the second contact part respectively electrically contact the PE terminal and the A-terminal to electrically connect the A-terminal to the PE terminal.

22. The DC charging dock of claim 21, wherein the PE terminal assembly includes a grounding cable and a first sealing component, the grounding cable is electrically connected to the PE terminal and led out from the first socket of the charging dock housing, the first sealing component is injection molded onto the PE terminal, the first sealing component is compressed between the PE terminal and an inner wall surface of the first socket to achieve sealing between the two.

23. The DC charging dock of claim 21, wherein the A-terminal assembly includes a second sealing component injection molded onto the A-terminal, the second sealing component is compressed between the A-terminal and an inner wall surface of the second socket to achieve sealing between the two.

24. The DC charging dock of claim 21, wherein a plurality of protrusions are formed on an outer side of a peripheral wall of the insertion slot of the charging dock housing, the plurality of protrusions are distributed around the insertion slot at intervals and respectively engage with a plurality of buckles on the insulator of the Low-voltage module to lock the Low-voltage module to the charging dock housing.

25. The DC charging dock of claim 21, wherein an axial direction of the insertion slot is perpendicular to an axial direction of the first socket and the second socket, the Low-voltage module is inserted into the insertion slot along a radial direction of the first socket and the second socket.

26. The DC charging dock of claim 21, wherein a third socket is formed in the charging dock housing, the insertion slot is in communication with the third socket, and the DC charging dock further comprises a power terminal assembly inserted into the third socket, the power terminal assembly has a power terminal, and a thermal pad of the Low-voltage module is in thermal contact with the power terminal to transfer a heat of the power terminal to a temperature sensor of the Low-voltage module.

27. The DC charging dock of claim 26, wherein the power terminal assembly includes a high-voltage cable and a sealing plug, the high-voltage cable is electrically connected to the power terminal and led out from the charging dock housing, the sealing plug is fitted onto the high-voltage cable and inserted into the third socket, the sealing plug is compressed between the high-voltage cable and an inner wall surface of the third socket to achieve sealing between the two.

28. The DC charging dock of claim 27, wherein the power terminal has a cylindrical part and a welding part, the cylindrical part mates with a mating power terminal, the welding part is connected to a rear end of the cylindrical part and is welded to the high-voltage cable, the thermal pad is in thermal contact with an outer peripheral surface of the cylindrical part and is adjacent to the welding part.

29. The DC charging dock of claim 28, wherein a seal installation groove is formed on the rear end of the cylindrical part, the power terminal assembly has a sealing ring installed in the seal installation groove, the sealing ring of the power terminal assembly is compressed between the cylindrical part and the inner wall surface of the third socket of the charging dock housing to achieve sealing between the two.

30. The DC charging dock of claim 26, wherein the charging dock housing has a plurality of third sockets, and the DC charging dock has a plurality of power terminal assemblies each inserted into one third socket, the insertion slot is in communication with each third socket, and the Low-voltage module includes a plurality of thermal pads respectively in thermal contact with the power terminals of the plurality of power terminal assemblies, and a plurality of temperature sensors respectively detecting a temperature of the power terminals.

31. The DC charging dock of claim 21, wherein the charging dock housing is an integral injection molded part.
